(19) United States
(12) Patent Application Publication
(10) Pub. No.: US 2017/0277944 A1
(43) Pub. Date: Sep. 28, 2017

(54) METHOD AND ELECTRONIC DEVICE FOR POSITIONING THE CENTER OF PALM

(71) Applicants: Le Holdings (Beijing) Co., Ltd., Beijing (CN); Le Shi Zhi Xin Electronic Technology (Tianjin) Limited, Tianjin (CN)

(72) Inventor: Yanjie Li, Tianjin (CN)

(73) Assignees: Le Holdings (Beijing) Co., Ltd., Beijing (CN); Le Shi Zhi Xin Electronic Technology (Tianjin) Limited, Tianjin (CN)

(21) Appl. No.: 15/245,159

(22) Filed: Aug. 23, 2016

Related U.S. Application Data
(63) Continuation of application No. PCT/CN2016/089380, filed on Jul. 8, 2016.

(30) Foreign Application Priority Data
Mar. 25, 2016 (CN) 201610177407.0

(51) Int. Cl. G06K 9/00; G06K 9/32; G06K 9/46; G06T 7/00

(52) U.S. Cl. CPC G06K 9/00382; G06T 7/0042; G06K 9/3216; G06K 9/4604; G06K 9/4652; G06K 9/00355

(57) ABSTRACT

The present invention provides a method and electronic device for palm center positioning, wherein the method for palm center positioning includes the following steps: firstly, acquires an image including a palm and an arm; then acquiring a connection area of the palm and the arm in the image based on skin color feature in the image; subsequently acquiring an exterior contour of the connection area, and clearly defining boundary of the connection area to eliminate errors; and finally acquiring palm center position information according to a maximum value of the shortest distance from each pixel point in the connection area within the exterior contour to the exterior contour. This disclosure is characterized by simple steps and high positioning accuracy.

### CROSS REFERENCE TO RELATED APPLICATIONS

This application is a continuation of International Application No. PCT/CN2016/089380 filed on Jul. 8, 2016, which is based upon and claims priority to Chinese Patent Application No. 201610177407. 0, filed on Mar. 25, 2016, titled “Method, Device and Intelligent Terminal for Palm Center Positioning and Gesture Recognition”, the entire contents of which are incorporated herein by reference.

### TECHNICAL FIELD

This disclosure relates to the field of computer vision and image processing technology, and, particularly relates to a method and electronic device for palm center positioning.

### BACKGROUND

With the rapid development of computer technology, novel interaction modes focusing on touch, voice, gesture, somatosensation and the like have become the research hotspot in recent years, so that the human-centered human-computer interaction technology has broad disclosure prospects. Where, gesture recognition is an important research direction in the field of human-computer interaction, and plays an important role in building intelligent human-computer interaction modes. But gesture is characterized in complexity, diversity, variability, spatio-temportal difference, etc., with the addition of interferences by external factors, such as light, temperature, etc., so that gesture recognition still has many technical difficulties, and has become a challenging research topic in the field of human-computer interaction.

The inventor found in the process of implementing this disclosure that fingers have slender shapes, and are difficult to be accurately recognized in images, while palms are wider. Therefore, if gestures are recognized based on palms, the difficulty of gesture recognition will be obviously reduced. Palm recognition focuses on palm center positioning. In the prior art, a triangle incremental method is often used for palm positioning, and includes the following steps: first acquiring a gesture contour image; then acquiring convexity defect depth points as a point set of the triangle incremental method by detecting convexity defects of a convex hull of the gesture contour; then forming a circle by taking the distance between any two convexity defect depth points selected from the point set as the diameter and taking the center of the distance between the two convexity defect points as the center of the circle; judging whether the circle includes all convexity defect depth points, positioning the palm center by taking this circle as the palm incircle if the circle includes all convexity defect depth points, or further selecting any convexity defect depth point outside the circle if the circle does not include all convexity defect depth points, and then judging whether a triangle formed by the three convexity defect depth points can form a right triangle or an obtuse triangle, reforming a circle by the two convexity defect depth points opposite to the right angle or the obtuse angle according to the above method if the triangle formed by the three convexity defect depth points can form a right triangle or an obtuse triangle, and judging whether the reformed circle includes all convexity defect depth points, positioning the palm center by taking the circle as the palm incircle if the reformed circle includes all convexity defect depth points, or further continuously repeating the above operations if the reformed circle does not include all convexity defect depth points, until forming a circle that can include all convexity defect depth points as the palm incircle for the palm center positioning. If the triangle formed by three convexity defect depth points is an acute triangle, the steps are more complex as follows: firstly, forming a circumcircle according to the acute triangle formed by the three convexity defect depth points, then judging whether the circle includes all convexity defect depth points, positioning the palm center by taking the circle as the palm incircle if the circle includes all convexity defect depth points, or further reselecting convexity defect depth points to continuously repeat the above steps if the circle does not include all convexity defect depth points, until forming a circle that can include all convexity defect depth points as the palm incircle. It is thus clear that in the prior art, the method for palm center positioning has complex steps. Moreover, errors, if any, in any one step will cause inaccurate positioning.

### SUMMARY

This disclosure discloses a method and electronic device for palm center positioning, which can overcome a problem that the method for palm center positioning has complex steps and low accuracy in the prior art.

Thus, this disclosure provides the following technical solution:

The embodiments of this disclosure provides a method for palm center positioning, including the following steps: acquiring an image including a palm and an arm; acquiring a connection area of the palm and the arm in the image based on skin color feature in the image; acquiring an exterior contour of the connection area; and acquiring position information of the palm center according to a maximum value of the shortest distance from each pixel point in the connection area within the exterior contour to the exterior contour.

The method further includes a step of, prior to the step of acquiring position information of the palm center according to a maximum value of the shortest distance from each pixel point in the connection area within the exterior contour to the exterior contour, filling holes, if the holes exist in the connection area within the exterior contour.

In the method, the step of acquiring position information of the palm center according to a maximum value of the shortest distance from each pixel point in the connection area within the exterior contour to the exterior contour includes: calculating the shortest distance from each pixel point in the connection area within the exterior contour to the exterior contour; acquiring a maximum value of the shortest distance; determining the position of a pixel point corresponding to the maximum value as the position of the palm center; and acquiring position information of the palm center.

Another objective of the embodiments of this disclosure is to provide an electronic device, including at least one processor, and a memory in communication connection with the at least one process; where the memory stores instructions that can be executed by the at least one processor, and the instructions are executed by the at least one processor to enable the at least one processor to: acquire an image including a palm and an arm; acquire a connection area of the palm and the arm in the image based on skin color feature in the image; acquire an exterior contour of the connection area; and acquire position information of the palm center according to a maximum value of the shortest distance from each pixel point in the connection area within the exterior contour to the exterior contour.

Optionally, before the step of acquiring position information of the palm center according to a maximum value of the shortest distance from each pixel point in the connection area within the exterior contour to the exterior contour, the method further includes a step of: filling holes, if the holes exist in the connection area within the exterior contour.

Another objective of the embodiments of this disclosure is to provide a non-volatile computer storage medium storing computer executable instructions that, when executed by an electronic device, enable the electronic device to: acquire an image including a palm and an arm; acquire a connection area of the palm and the arm in the image based on skin color feature in the image; acquire an exterior contour of the connection area; and acquire position information of the palm center according to a maximum value of the shortest distance from each pixel point in the connection area within the exterior contour to the exterior contour.

Optionally, before the step of acquiring position information of the palm center according to a maximum value of the shortest distance from each pixel point in the connection area within the exterior contour to the exterior contour, the method further includes a step of: filling holes, if the holes exist in the connection area within the exterior contour.

Optionally, the step of acquiring position information of the palm center according to a maximum value of the shortest distance from each pixel point in the connection area within the exterior contour to the exterior contour includes: calculating the shortest distance from each pixel point in the connection area within the exterior contour to the exterior contour; acquiring a maximum value of the shortest distance; determining the position of a pixel point corresponding to the maximum value as the position of the palm center; and acquiring position information of the palm center.

The technical solutions of the embodiments of this disclosure have the following advantages:

The embodiments of this disclosure provide a method and electronic device for palm center positioning, including the following steps: first acquiring an image including a palm and an arm; then acquiring a connection area of the palm and the arm in the image based on skin color feature in the image; subsequently acquiring an exterior contour of the connection area, and clearly defining boundary of the connection area to eliminate errors; and finally acquiring position information of the palm center according to a maximum value of the shortest distance from each pixel point in the connection area within the exterior contour to the exterior contour. The steps are simple and easy with high positioning accuracy.

The embodiments of this disclosure provide a method and electronic device for gesture recognition, including the following steps: acquiring position information of the palm center using the method for palm center positioning; determining a palm incircle by taking the palm center as the circle center, and taking the maximum value as the radius; and recognizing a gesture according to change value of position information of the palm center and/or change value of area of the palm incircle acquired within a preset time. The steps of palm center positioning are simple and easy with high positioning accuracy, thereby simplifying the gesture recognition steps and improving the gesture recognition efficiency.

### BRIEF DESCRIPTION OF THE DRAWINGS

One or more embodiments are illustrated by way of example, and not by limitation, in the corresponding figures of the accompanying drawings, where elements having the same reference numeral designations represent like elements throughout. The drawings are not to scale, unless otherwise disclosed.

FIG. 1 is a flow chart of a specific example of a method for palm center positioning according to embodiment 1 of this disclosure;

FIG. 2 is a schematic diagram of a specific example of an image including a palm and an arm acquired using a method for palm center positioning according to embodiment 1 of this disclosure;

FIG. 3 is a schematic diagram of a specific example of a connection area of a palm and an arm in a method for palm center positioning according to embodiment 1 of this disclosure;

FIG. 4 is a flow chart of a specific example of acquiring palm center position information using a method for palm center positioning according to embodiment 1 of this disclosure;

FIG. 5 is a flow chart of a preferred specific example of a method for palm center positioning according to embodiment 1 of this disclosure;

FIG. 6 is a schematic diagram of a specific example of a connection area with holes in a method for palm center positioning according to embodiment 1 of this disclosure;

FIG. 7 is a schematic diagram of the effect of filled connection area with holes in a method for palm center positioning according to embodiment 1 of this disclosure;

FIG. 8 is a block diagram of a structure of a specific example of an electric device for palm center positioning according to embodiment 2 of this disclosure;

FIG. 9 is a flow chart of a specific example of a method for gesture recognition according to embodiment 3 of this disclosure;

FIG. 10 is a block diagram of a structure of a specific example of an electronic device for gesture recognition according to embodiment 4 of this disclosure;

FIG. 11 is a schematic diagram of a hardware structure of an electronic device provided by the embodiments of this disclosure;

### REFERENCE NUMERALS IN THE DRAWINGS

1-Image acquiring unit; 2-Connection area acquiring unit; 3-Exterior contour acquiring unit; 4-Position information acquiring unit; a-Filling unit; 41-Shortest distance calculating subunit; 42-Maximum value acquiring subunit; 43-Palm center determining subunit; 44-Information acquiring subunit; 5-Position information acquiring unit; 6-Palm incircle determining unit; and 7-Gesture recognition unit.

### DETAILED DESCRIPTION

To make the objectives, the technical solution and the advantages of the embodiments of this disclosure clearer, hereinafter, the technical solution of this disclosure is clearly and completely described through implementation with reference to the accompanying drawings in the embodiments of this disclosure, and obviously, the described embodiments are a part, instead of all of the embodiments of this disclosure.

### Embodiment 1

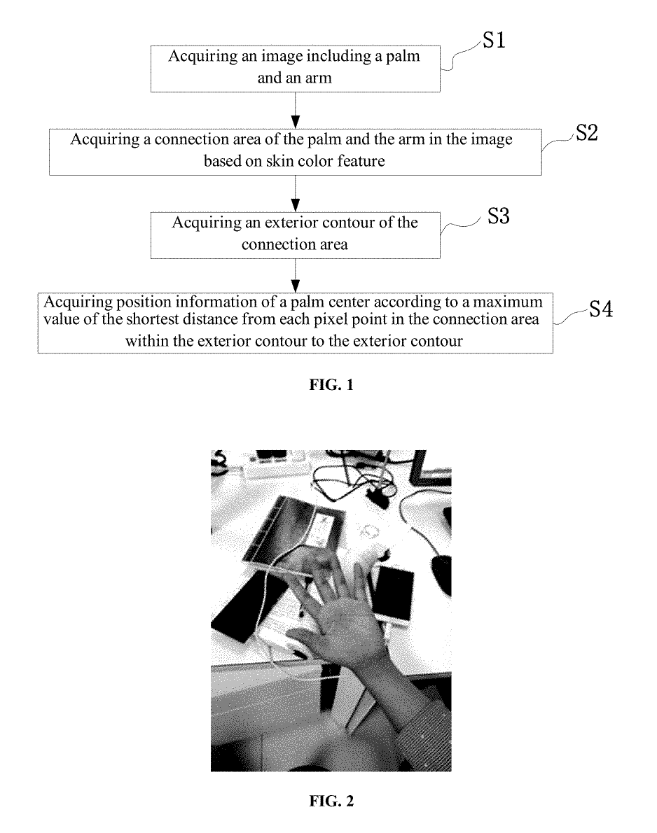

The embodiment provides a method for palm center positioning, as shown in FIG. 1, including the following steps:

S1: an image including a palm and an arm is acquired. Specifically, when a user makes a gesture in the coverage of a device, e.g. a camera, having functions, such as camera shooting and photographing, the device can shoot an image including the user's palm and arm and transfer the image to a storage device for storage, so as to acquire the above image including a palm and an arm from the storage device. FIG. 2 is an image including a palm and an arm.

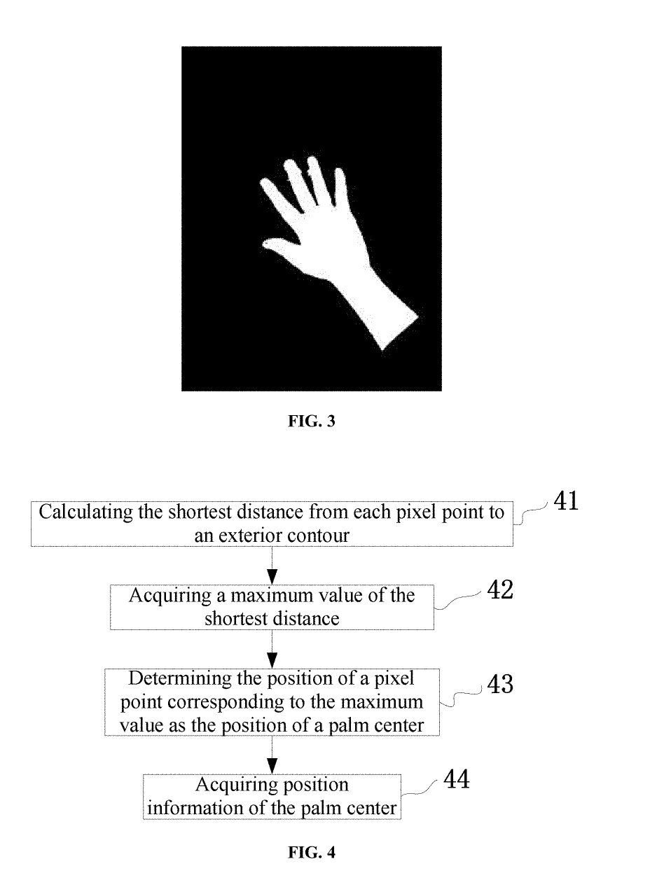

S2: a connection area of the palm and the arm in the image based on skin color feature in the image is acquired. Specifically, the image including the palm and the arm shown in FIG. 2, for instance, can be converted to HSV or YCrCb color space, and then each pixel point in the image is judged to belong to skin or non-skin based on the skin color feature, so that a connection area of the palm and the arm in the image is acquired, as shown in FIG. 3.

S3: an exterior contour of the connection area is acquired. Specifically, the exterior contour of the connection area can be acquired using cvFindContours function in OpenCV (Open Source Computer Vision Library). Acquiring an exterior contour of the connection area provides a reference for later palm center positioning. Optionally, deburring algorithm for binary image based on contour tracking can be used for further removing burrs on the exterior contour, and accurately defining boundary of the connection area of the palm and the arm, so as to further enhance the accuracy of the palm center positioning.

S4: position information of the palm center is acquired according to a maximum value of the shortest distance from each pixel point in the connection area within the exterior contour to the exterior contour. Specifically, according to position feature of a palm center, the maximum shortest distance shall be the shortest distance from a pixel point corresponding to the palm center position to the exterior contour. Acquiring the palm center position information according to a maximum value of the shortest distance from each pixel point in the connection area within the exterior contour to the exterior contour complies with the practical situation, and guarantees accurate palm center positioning.

Optionally, as shown in FIG. 4, step S4 includes the following substeps:

S41: the shortest distance from each pixel point in the connection area within the exterior contour to the exterior contour is calculated. Specifically, taking one pixel point thereof as an example, the shortest distance from the pixel point to the exterior contour can be selected by first traversing all contour points on the exterior contour, calculating the distance from the pixel point to each contour point, and then comparing the distance from the pixel point to each contour point after traversal. The shortest distance from each pixel point to the exterior contour can be acquired after traversing each pixel point in the connection area within the exterior contour using the above method. The distance from pixel points within a palm area to an exterior contour of fingers or the distance from pixel points in a finger area to the exterior contour of the palm can be eliminated in advance by calculating the shortest distance from each pixel point to the exterior contour, thereby reducing the misjudgment rate.

S42: a maximum value of the shortest distance is acquired. Specifically, the maximum value of the shortest distance can be acquired by comparing the shortest distance among each pixel point.

S43: the position of a pixel point corresponding to the maximum value is determined as the palm center position. Specifically, the maximum shortest distance shall be the shortest distance from a palm center to palm edge. Therefore, a pixel point corresponding to the maximum value of the shortest distance is the palm center position.

S44: position information of a palm center is acquired. Specifically, the position of a palm center in a gesture can be acquired according to the position of a pixel point corresponding to the palm center in the connection area of the palm and the arm as required, so as to estimate the current gesture accordingly; the motion track and the like of a palm center can be acquired by acquiring coordinates of pixel points corresponding to a plurality of palm centers of one palm within a preset time. Therefore, as long as a pixel point corresponding to the palm center position is determined, position information of a plurality of palm centers, e.g. palm center position and motion track, can be acquired to provide data support for subsequent gesture recognition.

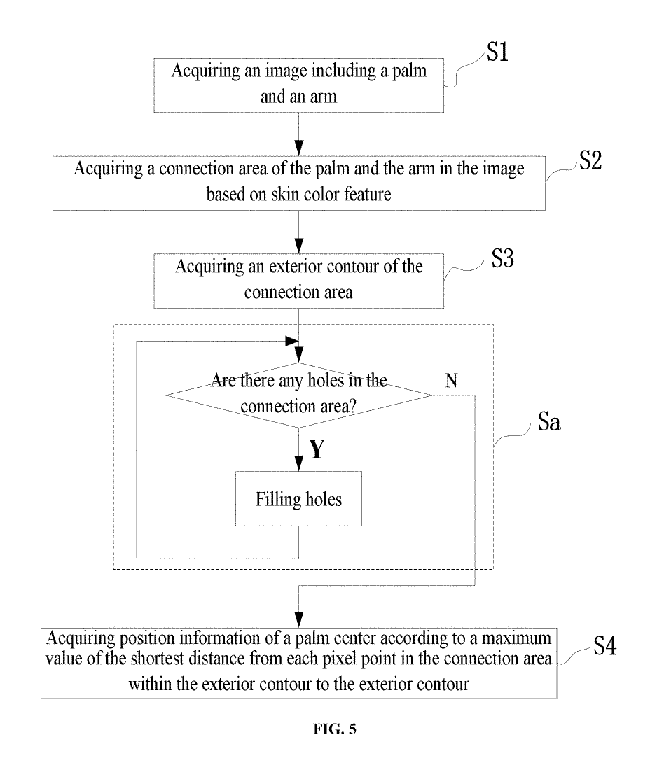

Optionally, as shown in FIG. 5, prior to step S4, the method further includes the following steps:

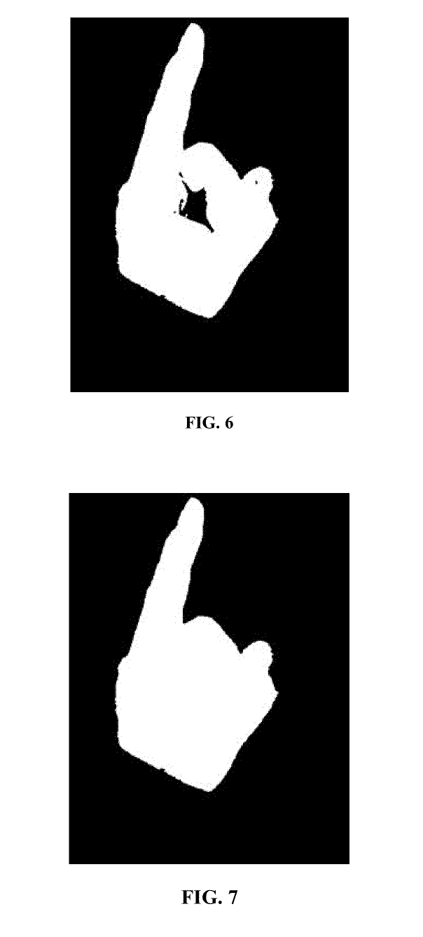

Sa: holes are filled, if the holes exist in a connection area within an exterior contour. Specifically, as shown in FIG. 6, the holes may exist in a connection area of a palm and an arm acquired based on skin color detection, and when the holes are located near the palm center area, pixel points corresponding to the palm center position may happen to be missing, thereby resulting in deviation of the palm center positioning, and going against subsequent accurate gesture recognition. Filling the holes ensures that a pixel point corresponding to the palm center position will not be missing, and reduces the error rate of palm center positioning. In practical disclosure, the holes can be filled using CvDrawContours function in OpenCV (Open Source Computer Vision Library). As can be seen from the filling effect shown in FIG. 7, a very good filling effect can be achieved. Of course, a region growing method may also be used for region growing by taking an exterior contour as the boundary, and taking any one pixel point within the exterior contour as the seed point, so that the holes within the exterior contour can be filled.

The method for palm center positioning according to the embodiment includes the following steps: firstly, an image including a palm and an arm is acquired; then a connection area of the palm and the arm in the image based on skin color feature in the image is acquired; subsequently, an exterior contour of the connection area is acquired, and boundary of the connection area is clearly defined to eliminate errors; and finally, the position information of the palm center can be acquired according to a maximum value of the shortest distance from each pixel point in the connection area within the exterior contour to the exterior contour. The method is characterized by simple steps and high positioning accuracy.

### Embodiment 2

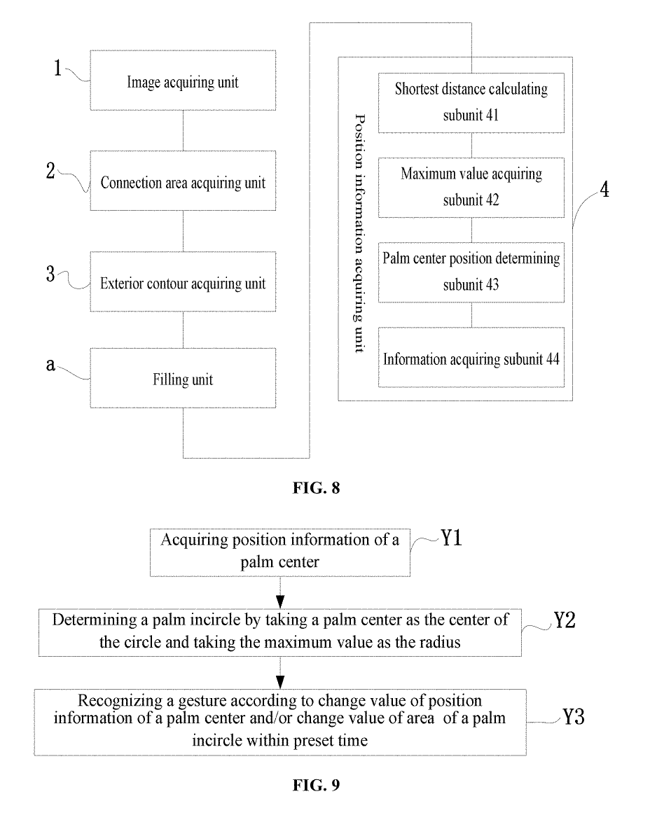

The embodiment provides a device for palm center positioning, as shown in FIG. 8, including the following units:

an image acquiring unit 1, for acquiring an image of a palm and an arm;

a connection area acquiring unit 2, for acquiring a connection area of the palm and the arm in the image based on skin color feature in the image;

an exterior contour acquiring unit 3, for acquiring an exterior contour of the connection area. By acquiring an exterior contour of the connection area, boundary of the connection area of a palm and an arm can be accurately defined, which provides an accurate reference standard for later palm center positioning, and improves the accuracy of palm center positioning.

and a position information acquiring unit 4, for acquiring palm center position information according to a maximum value of the shortest distance from each pixel point in the connection area within the exterior contour to the exterior contour. The step of acquiring the palm center position information according to a maximum value of the shortest distance from each pixel point in the connection area within the exterior contour to the exterior contour complies with the practical situation, and guarantees accurate palm center positioning.

Optionally, the position information acquiring unit 4 includes the following subunits:

a shortest distance calculating subunit 41, for calculating the shortest distance from each pixel point in the connection area within the exterior contour to the exterior contour.

a maximum value acquiring subunit 42, for acquiring a maximum value of the shortest distance;

a palm center determining subunit 43, for determining the position of a pixel point corresponding to the maximum value as the palm center position; and

an information acquiring subunit 44, for acquiring position information of the palm center.

Optionally, the device for palm center positioning according to the embodiment further includes a filling unit a for filling holes, if filling the holes exist in the connection area within the exterior contour. Filling the holes ensures that a pixel point corresponding to the palm center position will not be missing, and reduces the error rate of palm center positioning.

The device for palm center positioning according to the embodiment first acquires an image including a palm and an arm by the image acquiring unit 1; then acquires a connection area of the palm and the arm in the image based on skin color feature in the image by the connection area acquiring unit 2; subsequently acquires an exterior contour of the connection area by the exterior contour acquiring unit 3, and clearly defines boundary of the connection area to eliminate errors; and finally acquires the palm center position information by the position information acquiring unit 4 according to a maximum value of the shortest distance from each pixel point in the connection area within the exterior contour to the exterior contour. The device is characterized by simple steps and high positioning accuracy.

### Embodiment 3

The embodiment provides a gesture recognition method, as shown in FIG. 9, including the following steps:

Y1: The palm center position information is acquired by using the method for palm center positioning according to embodiment 1. The method for palm center positioning according to embodiment 1 includes the following steps: firstly, an image including a palm and an arm is acquired; then a connection area of the palm and the arm in the image based on skin color feature in the image is acquired; subsequently, an exterior contour of the connection area is acquired, and boundary of the connection area is clearly defined to eliminate errors; and finally, the palm center position information is acquired according to a maximum value of the shortest distance from each pixel point in the connection area within the exterior contour to the exterior contour. The method has simple steps and high positioning accuracy, thereby simplifying the gesture recognition steps, and improving the gesture recognition efficiency.

Y2: a palm incircle is determined by taking the palm center as the circle center, and taking the maximum value as the radius. Specifically, the shortest distance from a pixel point corresponding to a palm center to the exterior contour shall be the maximum shortest distance among all of the shortest distance. Therefore, a palm incircle relatively matching with the current palm area can be acquired by taking the palm center as the center of circle and taking the maximum value as the radius. Accordingly, the change value of its area can also accurately reflect the change value of area of the palm center. Radius of the palm incircle is positively correlated to the palm area, which is further positively correlated to the length of each finger. Therefore, the length and distribution range of each finger can be estimated using the radius of the palm incircle. For example, for different gestures, such as five fingers spreading and fisting, the palm area is bound to be different. Of course, area of the corresponding palm incircle is also different, and radius of the palm incircle is also different accordingly. In conclusion, a palm incircle relatively matching with the palm area can be acquired using the above method, thereby providing more accurate reference basis for later gesture recognition.

Y3: a gesture is recognized according to change value of position information of the palm center and/or change value of area of a palm incircle acquired within a preset time. Specifically, if the motion track of a hand is taken as the reference data for gesture recognition, only change value of position information of a palm center in a preset time needs to be acquired, and then motion track of the palm center can be acquired according to the change value of position information of the palm center. For example, a circular motion track represents a gesture, an S-shaped motion track represents another gesture, and so on; if gesture is recognized mainly based on recognition of the current state of a hand, only change value of area of a palm incircle within a preset time needs to be acquired, and then area change of the palm center is acquired accordingly to recognize whether the corresponding gesture is five fingers spreading or fisting, etc. Of course, more complex gestures may also be recognized by acquiring change value of position information of the palm center and change value of area of the palm incircle within a preset time, so as to generate more gesture control instructions. Examples of the more gestures include: five fingers spreading to draw a circle represents a gesture, five fingers spread to draw an S shape represents another gesture, fisting to draw a circle represents a third gesture, and so on.

The gesture recognition method according to the embodiment includes the following steps: firstly, an image including a palm and an arm is acquired; then a connection area of the palm and the arm in the image based on skin color feature in the image is acquired; subsequently, an exterior contour of the connection area is acquired, and boundary of the connection area is clearly defined to eliminate errors; and finally palm center position information is acquired according to a maximum value of the shortest distance from each pixel point in the connection area within the exterior contour to the exterior contour. The method is characterized in simple steps and high positioning accuracy, thereby simplifying the gesture recognition steps, and improving the gesture recognition efficiency.

### Embodiment 4

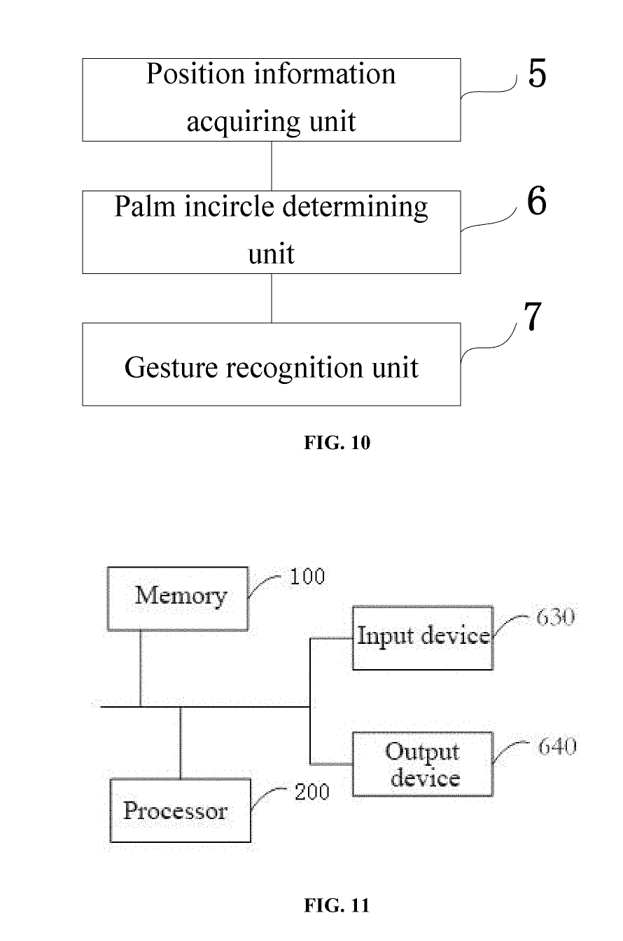

The embodiment provides a device for gesture recognition, as shown in FIG. 10, including the following units:

a position information acquiring unit 5, for acquiring position information of a palm center using a method for palm center positioning according to embodiment 1;

a palm incircle determining unit 6, for determining a palm incircle by taking the palm center as the circle center, and taking the maximum value as the radius; and

a gesture recognition unit 7, for recognizing a gesture according to change value of position information of a palm center and/or change value of area of a palm incircle acquired within a preset time.

The device for gesture recognition according to the embodiment first acquires an image including a palm and an arm; then acquires a connection area of the palm and the arm in the image based on skin color feature in the image; subsequently acquires an exterior contour of the connection area, and clearly defines boundary of the connection area to eliminate errors; and finally acquires palm center position information according to a maximum value of the shortest distance from each pixel point in the connection area within the exterior contour to the exterior contour. The device is characterized in simple steps and high positioning accuracy, thereby simplifying the gesture recognition steps, and improving the gesture recognition efficiency.

### Embodiment 5

The embodiment provides an intelligent terminal, including but not limited to, smart phones, smart TV, tablet PC, computers, etc. The intelligent terminal according to the embodiment includes a device for palm center positioning according to embodiment 2 and/or a device for gesture recognition according to embodiment 4.

The device for palm center positioning of the intelligent terminal according to the embodiment first acquires an image including a palm and an arm by the image acquiring unit; then acquires a connection area of the palm and the arm in the image based on skin color feature in the image by the connection area acquiring unit; subsequently acquires an exterior contour of the connection area by the exterior contour acquiring unit, and clearly defines boundary of the connection area to eliminate errors; and finally acquires palm center position information by the position information acquiring unit according to a maximum value of the shortest distance from each pixel point in the connection area within the exterior contour to the exterior contour. The device is characterized in simple steps and high positioning accuracy. Gestures are also recognized based on the palm center position information acquired using the above method for palm center positioning, and according to the change value of the position information of a palm center and/or the change value of area of a palm incircle acquired within a preset time, thereby simplifying the gesture recognition steps, and improving the gesture recognition efficiency.

### Embodiment 6

The embodiment provides an intelligent terminal, including but not limited to, smart phones, smart TV, tablet PC, computers, etc. The intelligent terminal according to the embodiment includes an image acquiring device and a device for palm center positioning according to embodiment 2.

The image acquiring device is used for acquiring an image including a palm and an arm. Specifically, the image acquiring device may be a camera installed on an intelligent terminal

The device for palm center positioning of the intelligent terminal according to the embodiment first acquires an image including a palm and an arm by the image acquiring unit; then acquires a connection area of the palm and the arm in the image based on skin color feature in the image by the connection area acquiring unit; subsequently acquires an exterior contour of the connection area by the exterior contour acquiring unit, and clearly defines boundary of the connection area to eliminate errors; and finally acquires palm center position information by the position information acquiring unit according to a maximum value of the shortest distance from each pixel point in the connection area within the exterior contour to the exterior contour. The device is characterized by simple steps and high positioning accuracy,

### Embodiment 7

The embodiment provides an intelligent terminal, including but not limited to, smart phones, smart TV, tablet PC, computers, etc. The intelligent terminal according to the embodiment includes an image acquiring device and a device for gesture recognition according to embodiment 4.

The image acquiring device is used for acquiring an image including a palm and an arm. Specifically, the image acquiring device may be a camera installed on an intelligent terminal

The device for gesture recognition of the intelligent terminal according to the embodiment first acquires an image including a palm and an arm; then acquires a connection area of the palm and the arm in the image based on skin color feature in the image; subsequently acquires an exterior contour of the connection area, and clearly defines boundary of the connection area to eliminate errors; and finally acquires palm center position information according to a maximum value of the shortest distance from each pixel point in the connection area within the exterior contour to the exterior contour. The device is characterized by simple steps and high positioning accuracy, thereby simplifying the gesture recognition steps, and improving the gesture recognition efficiency.

### Embodiment 8

The embodiments of this disclosure provide a non-volatile computer storage medium storing computer executable instructions that, when executed by an electronic device, enable the electronic device to: acquire an image including a palm and an arm; acquire a connection area of the palm and the arm in the image based on skin color feature in the image; acquire an exterior contour of the connection area; and acquire position information of the palm center according to a maximum value of the shortest distance from each pixel point in the connection area within the exterior contour to the exterior contour.

An a preferred implementation, before the step of acquiring position information of the palm center according to a maximum value of the shortest distance from each pixel point in the connection area within the exterior contour to the exterior contour, the method further includes a step of: filling holes, if the holes exist in the connection area within the exterior contour.

As another preferred implementation, the step of acquiring position information of the palm center according to a maximum value of the shortest distance from each pixel point in the connection area within the exterior contour to the exterior contour includes: calculating the shortest distance from each pixel point in the connection area within the exterior contour to the exterior contour; acquiring a maximum value of the shortest distance; determining the position of a pixel point corresponding to the maximum value as the position of the palm center; and acquiring position information of the palm center.

### Embodiment 9

FIG. 11 is a schematic diagram of a hardware structure of an electronic device for executing a method (subject name of the method, similarly hereinafter) for palm center positioning and gesture recognition provided by the embodiments of this disclosure. As shown in FIG. 11, the device includes one or more processors 200 (reference numerals modified in the accompanying drawings, similarly hereinafter); a memory; and a memory 620 (reference numerals modified in the accompanying drawings, similarly hereinafter), and one processor 200 is taken as an example in FIG. 11. The device for executing the method for palm center positioning and gesture recognition may further include: an input device 630 and in output device 640.

The processor 200, the memory 100, the input device 630 and the output device 640 may be connected by a bus or in other ways, and bus connection is taken as an example in FIG. 11.

The memory 100, as a non-volatile computer readable storage medium, may be used for storing non-volatile software programs, non-volatile computer executable programs and modules, for example, program instructions/modules (e.g., a image acquiring unit 1, a connection area acquiring unit 2, an exterior contour acquiring unit 3, and a position information acquiring unit 4 shown in FIG. 8) corresponding to the method for palm center positioning and gesture recognition in the embodiments of this disclosure. The processor 200 runs the non-volatile software programs, instructions and modules stored in the memory 100, so as to execute various functional disclosures and data processing of a server, i.e., implementing the method for palm center positioning and gesture recognition in accordance with the abovementioned embodiments of the method.

The memory 100 may include a program storage area and a data storage area, where the program storage area may store an operating system and disclosures for at least one functions; and the data storage area may store data and the like created according to the use of a device for palm center positioning and gesture recognition. Moreover, the memory 100 may include a high-speed random access memory, and may also include a non-volatile memory, for example, at least one disk storage device, a flash memory, or other non-volatile solid storage devices. In some embodiments, the memory 100 optionally includes memories that are set remotely relative to the processor 200, and these remote memories may be connected to the device for palm center positioning and gesture recognition through a network. An example of the network includes, but is not limited to, internet, intranet, LAN, mobile communication network, and the combinations thereof.

The input device 630 may receive input digit or character information, and generate a key signal input related to the user configuration and function control of the device for palm center positioning and gesture recognition. The output device 640 may include display devices such as a display screen.

The one or more modules are stored in the memory 100, and when executed by the one or more processors 200, execute the method for palm center positioning and gesture recognition in any one of the abovementioned embodiments of the method.

The abovementioned product can execute the method provided by the embodiments of this disclosure and has corresponding functional modules for executing the method and beneficial effects. For more technical details that are not described in detail in this embodiment, please refer to the method provided by the embodiments of this disclosure.

The electronic device of the embodiments of this disclosure exists in many forms, including but not limited to, the following devices:

(1) Mobile communication devices: the characteristic of such devices is that they have a mobile communication function with a main goal of enabling voice and data communication. Such terminals include: smart phones (such as iPhone), multimedia phones, feature phones, low-end phones, etc.

(2) Ultra-mobile personal computer devices: such devices belong to the category of personal computers, have computing and processing functions, and usually also have mobile internet access features. Such terminals include: PDA, MID, UMPC devices, etc., such as iPad.

(3) Portable entertainment devices: such devices are able to display and play multimedia contents. Such devices include: audio and video players (such as iPod), handheld game players, electronic books, intelligent toys, and portable vehicle navigation devices.

(4) Servers: devices providing computing services. The components of servers include a processor, a hard disk, an internal memory, an electronic device bus, etc. The structures of the servers are similar to the structures of general purpose computers, but in order to provide highly reliable services, the servers have higher requirements in aspects of processing capability, stability, reliability, security, expandability, manageability, etc.

(5) Other electronic devices having data interaction function.

The abovementioned embodiments of the device are only illustrative, where the units described as separate parts may be or may also not be physically separated, the components shown as units may be or may also not be physical units, i.e. may be located in one place, or may also be distributed to multiple network units. According to actual needs, part of or all of the modules therein may be selected to realize the objectives of the solution of the embodiment.

By abovementioned descriptions of the embodiments, those skilled in the art can clearly understand that the various embodiments may be implemented by software and a general hardware platform, or just by hardware. Based on such understanding, the abovementioned technical solution in essence, or the part thereof making contribution to a related art, may be reflected in the form of a software product, and such a computer software product may be stored in a computer readable storage medium such as an ROM/RAM, a magnetic disk or an optical disk, etc., and may include a number of instructions to enable a computer device (which may be a personal computer, a server, or a network device, or the like) to execute the method described in the various embodiments or in some parts thereof.

Finally, it should be noted that: the abovementioned embodiments are merely illustrated for describing rather than limiting the technical solution of this disclosure; although detailed description of this disclosure is given with reference to the abovementioned embodiments, those skilled in the art should understand that they still can modify the technical solution recorded in the abovementioned various embodiments or replace part of the technical features therein with equivalents; and these modifications or replacements would not cause the essence of the corresponding technical solution to depart from the spirit and scope of the technical solution of the various embodiments of this disclosure.

1. A method for palm center positioning, applied to an electronic device, comprising the following steps:
acquiring an image comprising a palm and an arm;
acquiring a connection area of the palm and the arm in the image based on skin color feature in the image;
acquiring an exterior contour of the connection area; and
acquiring position information of the palm center according to a maximum value of the shortest distance from each pixel point in the connection area within the exterior contour to the exterior contour.

2. The method according to claim 1, further comprising the following step, prior to the step of acquiring position information of the palm center according to a maximum value of the shortest distance from each pixel point in the connection area within the exterior contour to the exterior contour:
filling holes, if the holes exist in the connection area within the exterior contour.

3. The method according to claim 1, wherein the step of acquiring position information of the palm center according to a maximum value of the shortest distance from each pixel point in the connection area within the exterior contour to the exterior contour comprises:
calculating the shortest distance from each pixel point in the connection area within the exterior contour to the exterior contour;
acquiring a maximum value of the shortest distance;
determining the position of a pixel point corresponding to the maximum value as the position of the palm center; and
acquiring position information of the palm center.

4. An electronic device, comprising at least one processor, and a memory in communication connection with the at least one processor; wherein the memory stores instructions that can be executed by the at least one processor, and the instructions are executed by the at least one processor to enable the at least one processor to:
acquire an image of a palm and an arm;
acquire a connection area of the palm and the arm in the image based on skin color feature in the image;
acquire an exterior contour of the connection area; and
acquire position information of a palm center according to a maximum value of the shortest distance from each pixel point in the connection area within the exterior contour to the exterior contour.

5. The electronic device according to claim 4, wherein the instructions enable the at least one processor to further: fill holes, if the holes exist in the connection area within the exterior contour, before the step to acquire position information of the palm center according to a maximum value of the shortest distance from each pixel point in the connection area within the exterior contour to the exterior contour.

6. The electronic device according to claim 4, wherein the instructions enable the at least one processor to:
calculate the shortest distance from each pixel point in the connection area within the exterior contour to the exterior contour;
acquire a maximum value of the shortest distance;
determine the position of a pixel point corresponding to the maximum value as the position of the palm center; and
acquire position information of the palm center.

7. A non-transitory computer-readable storage medium storing executable instructions that, when executed by an electronic device, cause the electronic device to:
acquire an image comprising a palm and an arm;
acquire a connection area of the palm and the arm in the image based on skin color feature in the image;
acquire an exterior contour of the connection area; and
acquire position information of the palm center according to a maximum value of the shortest distance from each pixel point in the connection area within the exterior contour to the exterior contour.

8. The non-volatile computer storage medium according to claim 7, wherein, the electronic device is further caused to
fill holes, if the holes exist in the connection area within the exterior contour, prior to the step to acquire position information of the palm center according to a maximum value of the shortest distance from each pixel point in the connection area within the exterior contour to the exterior contour.

9. The non-volatile computer storage medium according to claim 7, wherein, the electronic device is further caused to
calculate the shortest distance from each pixel point in the connection area within the exterior contour to the exterior contour;
acquire a maximum value of the shortest distance;
determine the position of a pixel point corresponding to the maximum value as the position of the palm center; and
acquire position information of the palm center.

10. The method according to claim 2, wherein the step of acquiring position information of the palm center according to a maximum value of the shortest distance from each pixel point in the connection area within the exterior contour to the exterior contour comprises:
calculating the shortest distance from each pixel point in the connection area within the exterior contour to the exterior contour;
acquiring a maximum value of the shortest distance;
determining the position of a pixel point corresponding to the maximum value as the position of the palm center; and
acquiring position information of the palm center.
